(19) United States
(12) Patent Application Publication
(10) Pub. No.: US 2023/0132038 A1
(43) Pub. Date: Apr. 27, 2023

(54) METHOD FOR PROVIDING ONLINE SHOPPING INFORMATION BASED ON VIDEO ANALYSIS

(71) Applicant: LINE Plus Corporation, Seongnam-si (KR)

(72) Inventor: Eun Bin KANG, Seongnam-si (KR)

(73) Assignee: LINE Plus Corporation, Seongnam-si (KR)

(21) Appl. No.: 17/963,008

(22) Filed: Oct. 10, 2022

(30) Foreign Application Priority Data
Oct. 27, 2021 (KR) 10-2021-0144154

(51) Int. Cl. G06Q 30/06; H04N 21/4725

(52) U.S. Cl. CPC G06Q 30/0627; G06Q 30/0643; H04N 21/4725

(57) ABSTRACT

A method for providing online shopping information based on video analysis is performed by one or more processors of a user terminal. The method includes while a video is playing, outputting a first tag associated with a first object included in the video, at a location adjacent to the first object, while the video is playing, outputting a second tag associated with a second object included in the video, at a location adjacent to the second object, while the video is playing, receiving a first user input of selecting the first tag, the first user input being a first input of a user of the user terminal, and in response to receiving the first user input, outputting information on a first product registered in an online shopping platform associated with the first object.

### CROSS-REFERENCE TO RELATED APPLICATION

This application claims priority under 35 U.S.C § 119 to Korean Patent Application No. 10-2021-0144154, filed in the Korean Intellectual Property Office on Oct. 27, 2021, the entire contents of which are hereby incorporated by reference.

### BACKGROUND

### Technical Field

The present disclosure relate to methods for providing online shopping information based on video analysis, and more particularly, to methods for providing online shopping information based on video analysis, which output a tag associated with an object included in a video, and output information on a product registered in an online shopping platform associated with the object based on a user input for the tag.

### Description of Related Art

With the widespread use of e-commerce for purchases of products or services on media such as PCs or mobile devices, there are diverse forms of e-commerce platforms available. In particular, in recent years, live-commerce is rapidly emerging as a new trend, which is a way of introducing products to consumers through real-time video streaming. The live-commerce is similar to the existing home shopping, but has the characteristic that consumers and sellers can communicate with each other using chats.

However, in the related live commerce, it is necessary to produce a separate video for the purpose of introducing a product to be sold, which is cumbersome. In addition, the producer of the video has to manually input information on the product to be sold in the video in order to motivate the viewer to buy the product. In addition, since the viewers watching the video are inevitably limited to those who are interested in the product for sale, there is a limit to induce the influx of new viewers. Accordingly, there is an increasing need for a system that automatically searches for products appearing in a video watched by more users and also provides a shopping function.

### SUMMARY

In order to address one or more problems (e.g., the problems described above and/or other problems not explicitly described herein), the present disclosure may provide methods for, non-transitory computer-readable recording mediums storing instructions for, and/or apparatuses (systems) for providing online shopping information based on video analysis.

The methods, non-transitory computer-readable recording mediums, and/or apparatuses for providing online shopping information based on video analysis, which output a tag associated with an object included in a video, and output information on a product registered in an online shopping platform associated with the object based on a user input for the tag, may be provided.

A method for providing online shopping information based on video analysis may be performed by one or more processors of a user terminal. The method may include while the video is playing, outputting a first tag associated with a first object included in a video, at a location adjacent to the first object, while the video is playing, outputting a second tag associated with a second object included in the video, at a location adjacent to the second object, while the video is playing, receiving a first user input of selecting the first tag, the first user input being a first input of a user of the user terminal, and in response to receiving the first user input, outputting information on a first product registered in an online shopping platform associated with the first object.

The first tag and the second tag may be displayed if the user activates a shopping link function at a video player.

The information on the first product may include at least one of a sale price, seller information, buyer rating information, or a product image.

The first object included in the video may have a similarity equal to or greater than a first threshold with respect to the product image included in the information on the first product.

The second object included in the video may have a similarity equal to or greater than a second threshold and less than the first threshold with respect to a product image of a second product registered in the online shopping platform, and the first tag may be displayed with a first visual object, and he second tag may be displayed with a second visual object different from the first visual object.

The method may further include receiving a second user input of selecting an icon for purchasing the first product, the second user input being a second input of the user, and in response to receiving the second user input, outputting a web page for purchasing the first product on the online shopping platform.

The first tag and the second tag may be output in response to determining that the first object and the second object belong to a specific shopping category selected by a user.

The first tag and the second tag may be output in response to determining that the first object and the second object are associated with a product searched by the user within a period of time.

The first tag and the second tag may be output in response to determining that the first object and the second object are not associated with a product purchased by the user within a period of time.

The first tag may be displayed with a first visual object in response to determining that the first object is a consumable, and the second tag may be displayed with a second visual in response to determining that the second object is non-consumable, in which the first visual object and the second visual object may be different from each other.

The method may further include, in response to determining that a period of time has elapsed since a purchase of the first object by the user based on a purchase record of the user in the online shopping platform, outputting a third visual object indicating that the time for purchasing the first product that is a consumable has arrived, together with the first tag at a location adjacent to the first object.

The method may further include, in response to determining that a number of users who have selected the first tag and purchased the first product while the video is playing is equal to or greater than a threshold, outputting a visual object indicating that the first product is a popular product, together with the first tag at a location adjacent to the first object.

The method may further include receiving a third user input of selecting an icon for the user to manually select the object in the video, the third user input being a third input of the user, in response to receiving the third user input, stopping play of the video, and receiving a fourth user input of selecting a third object in the video, the fourth user input being a fourth input of the user.

The fourth user input may be a user input of drawing a figure of any shape surrounding the third object.

The fourth user input may be a user input of rubbing an area corresponding to the third object.

The method may further include outputting a user interface for inputting information on a shopping category to which the third object belongs.

The method may further include outputting a second set of products of the first set of products registered in the online shopping platform, the second set of products belonging to a same shopping category as the third object and be associated with a product image having a similarity equal to or greater than a third threshold with respect to the third object, and receiving, as a fifth user input, a selection of a second product from among the second set of products, the fifth user input being a fifth input of the user, the second set of products being a subset of the first set of products.

The method may further include, in response to receiving the fifth user input, transmitting information on the video, information on the third object, and information on the second product to an information processing system.

A non-transitory computer-readable recording medium storing instructions that, when executed by one or more processors, cause a user terminal to perform the aforementioned method for providing online shopping information based on video analysis on a computer may be provided.

A user terminal may include a memory and one or more processors connected to the memory and configured to execute one or more computer-readable programs included in the memory such that the one or more processors are configured to perform a method, which includes while a video is playing, outputting a first tag associated with a first object included in the video, at a location adjacent to the first object, while the video is playing, outputting a second tag associated with a second object included in the video, at a location adjacent to the second object, while the video is playing, receiving a first user input of selecting the first tag, the first user input being a first input of a user of the user terminal, and in response to receiving the first user input, outputting information on a first product registered in an online shopping platform associated with the first object.

The convenience of online shopping while the user is watching a video can be improved.

The video service provider may naturally expose the shopping information of the product for sale for the notice of the user 110, thereby improving the usage rate of the online shopping platform.

The user can easily purchase, among the products for sale registered on the online shopping platform, a product that is identical to or has a high similarity to the product appearing in the video.

The user can easily check the object associated with the tag selected by the user in the video that includes a plurality of objects, by checking the object positioned adjacent to the tag in the changed color.

The user can purchase consumables without missing an appropriate time, without having to individually check whether or not various consumables with different usage cycles are exhausted.

The user can reduce or prevent an excessive number of tags from being displayed and interfere with the video watching while the video is playing, and allow only the tags that are likely to be of interest to be displayed.

The user can easily select a desired object from the still screen of the video.

The video service provider may accumulate the online shopping information associated with the object in the video.

### BRIEF DESCRIPTION OF THE DRAWINGS

The above and other objects, features and advantages of the present disclosure will become more apparent to those of ordinary skill in the art by describing in detail some example embodiments thereof with reference to the accompanying drawings, in which:

FIG. 1 illustrates an example of using a service for providing online shopping information based on video analysis;

FIG. 2 is a schematic diagram illustrating a configuration in which an information processing system is communicatively connected to a plurality of user terminals in order to provide a service for providing online shopping information based on video analysis;

FIG. 3 is a block diagram of an internal configuration of the user terminal and the information processing system;

FIG. 4 illustrates an example of activating a shopping link function;

FIG. 5 illustrates an example in which a plurality of tags are output;

FIG. 6 illustrates an example in which a tag filter is used;

FIG. 7 illustrates an example in which a filter A is used;

FIG. 8 illustrates an example in which a filter B is used;

FIG. 9 illustrates an example of manually selecting an object in a video;

FIG. 10 illustrates an example of displaying a visual object indicating a popular product; and

FIG. 11 illustrates an example of a method for providing online shopping information based on video analysis.

### DETAILED DESCRIPTION

Hereinafter, some example embodiments for the practice of the present disclosure will be described in detail with reference to the accompanying drawings. However, in the following description, detailed description of well-known functions or configurations will be omitted when it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to the example embodiments described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example embodiment(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example embodiment(s). Therefore, the terms used in the present disclosure should be defined based on the meaning of the terms and the overall content of the present disclosure rather than a simple name of each of the terms.

As used herein, the singular forms “a,” “an.” and “the” are intended to include the plural forms as well, unless the context clearly indicates the singular forms. Further, the plural forms are intended to include the singular forms as well, unless the context clearly indicates the plural forms. Further, throughout the description, if a portion is stated as “comprising (including)” a component, it intends to mean that the portion may additionally comprise (or include or have) another component, rather than excluding the same, unless specified to the contrary.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

Further, the term “module” or “unit” used herein refers to software, hardware, or a combination of software and hardware, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as processing circuitry or a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

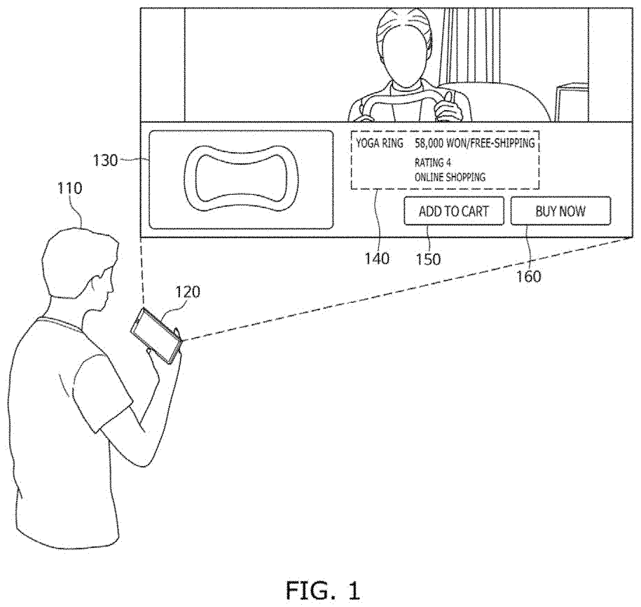

FIG. 1 illustrates an example of using a service for providing online shopping information based on video analysis. As illustrated, while watching a video using a user terminal 120, a user 110 may check online shopping information 130 and 140 associated with a product appearing in the video. In this case, the online shopping information 130 and 140 may refer to information on products for sale registered in the online shopping platform.

Because the video simply conveys only the visual appearance information of the product such as the shape, size, and color, it is difficult for the user 110 to obtain information on the same product for sale as the product appearing in the video. Meanwhile, when a service for providing online shopping information based on video analysis is used, the user 110 may be provided with the information (e.g., selling price, seller information, buyer rating information, and the like) on the same or similar product for sale as the product appearing in the video without conducting a separate search. In this case, the product for sale may be a product registered in the online shopping platform. With such a configuration, the user 110 who is viewing a video can experience enhanced convenience of using the online shopping. In addition, the video service provider may naturally expose the shopping information of the product for sale for the user 110 to notice, thereby improving the usage rate of the online shopping platform.

The user 110 may select the product appearing in the video to check the online shopping information 130 and 140 associated with the selected product. For example, if there is a product for sale having a similarity of 90% or more to an object appearing in the video, the user 110 may select a tag associated with the corresponding object to check the online shopping information for a product for sale that is similar to the corresponding object. With such a configuration, the user 110 can easily purchase, among the products for sale registered on the online shopping platform, a product that is identical to or has a high similarity to the product appearing in the video.

The user 110 may put the product for sale that is the same as or similar to the product appearing in the video in a shopping cart of the online shopping platform. For example, the user 110 may select a shopping cart icon 150 by a touch input or the like to put the corresponding product for sale in the shopping cart of the online shopping platform. Accordingly, the user 110 may, while watching several videos, put products for sale that are the same as or similar to the objects appearing in the videos in the shopping cart, and purchase the products for sale put in the shopping cart at once on the online shopping platform.

The user 110 may move to a screen for purchasing the products for sale that are the same as or similar to the products appearing in the video. For example, the user 110 may select a purchase icon 160 by a touch input or the like to move to a screen of the online shopping platform for purchasing products for sale. In some example embodiments, the user 110 may directly purchase the product for sale using a function such as immediate purchase and the like on the screen where the video is being played.

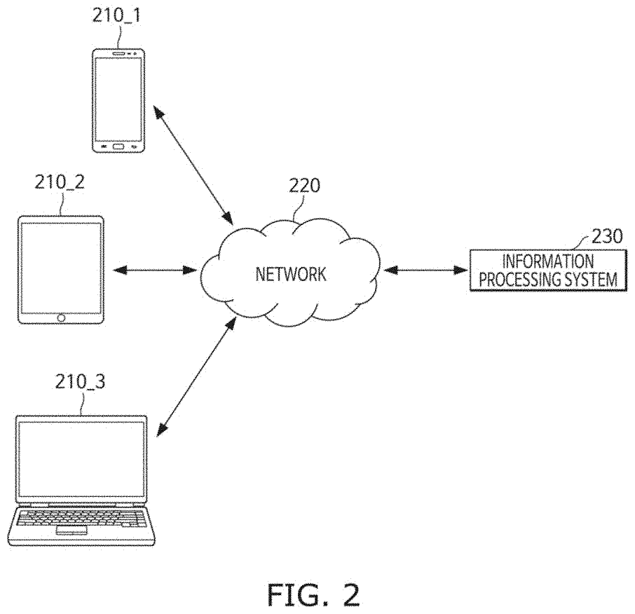

FIG. 2 is a schematic diagram illustrating a configuration in which an information processing system 230 is communicatively connected to a plurality of user terminals 210_1, 210_2, and 210_3 to provide the service for providing online shopping information based on video analysis. The information processing system 230 may include a system(s) capable of providing a service for providing online shopping information based on video analysis through a network 220. The information processing system 230 may include one or more server devices and/or databases, or one or more distributed computing devices and/or distributed databases based on cloud computing services that can store, provide and execute computer-executable programs (e.g., downloadable applications) and data relating to the service for providing online shopping information based on video analysis. For example, the information processing system 230 may include separate systems (e.g., servers) for providing the service for providing online shopping information based on video analysis.

The service for providing online shopping information based on video, which may be provided by the information processing system 230, may be provided to the user via an application for providing online shopping information based on video, which may be installed in each of the plurality of user terminals 210_1, 210_2, and 210_3, a web browser, or the like. In some example embodiments, the service for providing online shopping information based on video, which may be provided by the information processing system 230, may be provided to the user as a part of a video play service, via a video platform application, a video player application, a shopping application, a search application, a social network application, a mobile browser application, a web browser, or the like, which may be installed in each of the plurality of user terminals 210_1, 210_2, and 210_3.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and so on) that may be included in the network 220 as well as short-range wireless communication between the user terminals 210_1, 210_2, and 210_3.

In FIG. 2, the mobile phone terminal 210_1, the tablet terminal 210_2, and the PC terminal 210_3 are illustrated as the examples of the user terminals, but example embodiments are not limited thereto, and the user terminals 210_1, 210_2, and 210_3 may be any computing device that is capable of wired and/or wireless communication and is equipped with an image sensor. For example, the user terminal may include a smartphone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and the like. In addition, while FIG. 2 illustrates that three user terminals 210_1, 210_2, and 210_3 are in communication with the information processing system 230 through the network 220, aspects are not limited thereto, and a different number of user terminals may be configured to be in communication with the information processing system 230 through the network 220. The plurality of user terminals 210_1, 210_2, and 210_3 may be user terminals of the users who use the service for providing online shopping information based on video.

The information processing system 230 may receive data (e.g., information on shopping category) input from the user terminal via an application for providing online shopping information based on video, or the like, operating on the user terminal. The information processing system 230 may store and/or transmit the received data to another user terminal connected to the network 220. Additionally, the information processing system 230 may control the service for providing online shopping information based on video, based on a user input from the user terminal.

The information processing system 230 may analyze the data (e.g., video) input from the user terminal via an application for providing online shopping information, or the like, based on a video operating in the user terminal. For example, the information processing system 230 may extract an object (e.g., furniture, clothing, props, and the like) from N frame images per second of a video. Then, the information processing system 230 may compare the extracted object with pre-stored data (e.g., a product image stored in the online shopping platform), and calculate a similarity between the extracted object and the pre-stored data. Based on the calculated similarity, the information processing system 230 may tag the object (e.g., furniture, clothing, props, and the like) with a tag including specific information (e.g., a specific link of a web page providing online shopping service). For example, the information processing system 230 may store the extracted object and the information on product having a similarity equal to or greater than a desired (or alternatively, predetermined) threshold (e.g., 90%) in association with each other.

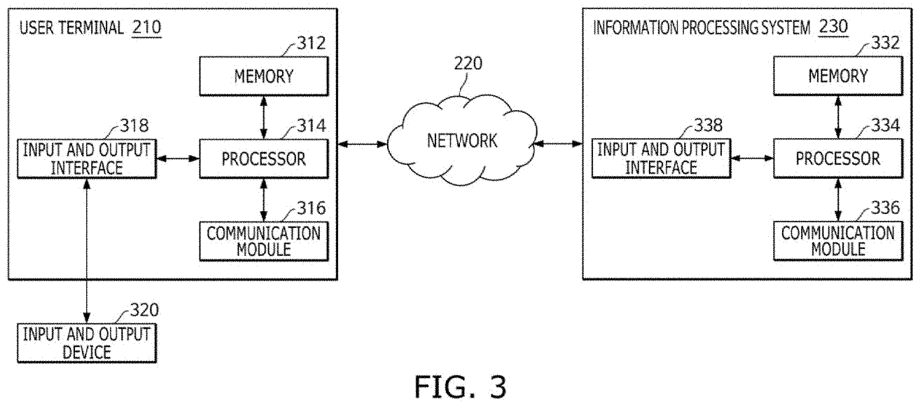

FIG. 3 is a block diagram of an internal configuration of the user terminal 210 and the information processing system 230. The user terminal 210 may refer to any computing device that is capable of executing the application for providing online shopping information based on video, the web browser application, and the like, and that is capable of wired and wireless communication, and may include the mobile phone terminal 210_1, the tablet terminal 210_2, and the PC terminal 210_3 of FIG. 2, and the like. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using respective communication modules 316 and 336. In addition, an input and output device 320 may be configured to input information and/or data to the user terminal 210 or output information and/or data generated from the user terminal 210 through the input and output interface 318.

The memories 312 and 332 may include any non-transitory computer-readable recording medium. The memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. In addition, an operating system and at least one program code (e.g., a code for the application for providing online shopping information based on video, and the like installed and driven in the user terminal 210) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and so on, for example. As another example, the software components may be loaded into the memories 312 and 332 through the communication modules rather than the computer-readable recording medium. For example, at least one program may be loaded into the memories 312 and 332 based on a computer program (for example, the application for providing online shopping information based on video) installed by files provided by developers or a file distribution system for distributing an installation file of the application through the network 220.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system or the like). For example, a request or data (e.g., a request to activate shopping link function, information on shopping category, and the like) generated by the processor 314 of the user terminal 210 according to the program code stored in the recording device such as the memory 312 or the like may be transmitted to the information processing system 230 through the network 220 under the control of the communication module 316. Conversely, a control signal or a command provided under the control of the processor 334 of the information processing system 230 may be received by the user terminal 210 through the communication module 316 of the user terminal 210 through the communication module 336 and the network 220.

The input and output interface 318 may be a means for interfacing with the input and output device 320. As an example, the input device may include a device such as a camera including an audio sensor and/or an image sensor, a keyboard, a microphone, a mouse, and so on, and the output device may include a device such as a display, a speaker, a haptic feedback device, and so on. As another example, the input and output interface 318 may be a means for interfacing with a device such as a touch screen or the like that integrates a configuration or function for performing inputting and outputting.

While FIG. 3 illustrates that the input and output device 320 is not included in the user terminal 210, aspects are not limited thereto, and the input and output device 320 may be configured as one device with the user terminal 210. In addition, the input and output interface 338 of the information processing system 230 may be a means for interfacing with a device (not illustrated) for inputting or outputting that may be connected to, or included in the information processing system 230. While FIG. 3 illustrates the input and output interfaces 318 and 338 as the components configured separately from the processors 314 and 334, aspects are not limited thereto, and the input and output interfaces 318 and 338 may be configured to be included in the processors 314 and 334.

The user terminal 210 and the information processing system 230 may include more than those components illustrated in FIG. 3. Meanwhile, most of the related components may not necessarily require exact illustration. The user terminal 210 may be implemented to include at least a part of the input and output device 320 described above. In addition, the user terminal 210 may further include other components such as a transceiver, a Global Positioning System (GPS) module, a camera, various sensors, a database, and the like. For example, when the user terminal 210 is a smartphone, it may include components generally included in the smartphone. For example, in an implementation, various components such as an acceleration sensor, a gyro sensor, a camera module, various physical buttons, buttons using a touch panel, input and output ports, a vibrator for vibration, and so on may be further included in the user terminal 210.

The processor 314 of the user terminal 210 may be configured to operate the application for providing online shopping information based on video, or the web browser application. The program code associated with the corresponding application may be loaded into the memory 312 of the user terminal 210. While the application is running, the processor 314 of the user terminal 210 may receive information and/or data provided from the input and output device 320 through the input and output interface 318 or receive information and/or data from the information processing system 230 through the communication module 316, and process the received information and/or data and store it in the memory 312. In addition, such information and/or data may be provided to the information processing system 230 through the communication module 316.

While the application for providing online shopping information based on video or the web browser application is running, the processor 314 may receive text, image, video, and the like input or selected through the input device such as a camera, a microphone, and the like including a touch screen, a keyboard, an audio sensor and/or an image sensor connected to the input and output interface 318, and store the received text, image, and/or video or the like in the memory 312, or provide it to the information processing system 230 through the communication module 316 and the network 220.

The processor 334 of the information processing system 230 may be configured to manage, process, and/or store the information and/or data received from a plurality of user terminals and/or a plurality of external systems. The processor 334 may store, process, and transmit a photo, video, audio, document, contact list, text, and the like received from the user terminal 210. In some example embodiments, the processor 334 may control the service for providing online shopping information based on video, in response to a user input received from the user terminal 210.

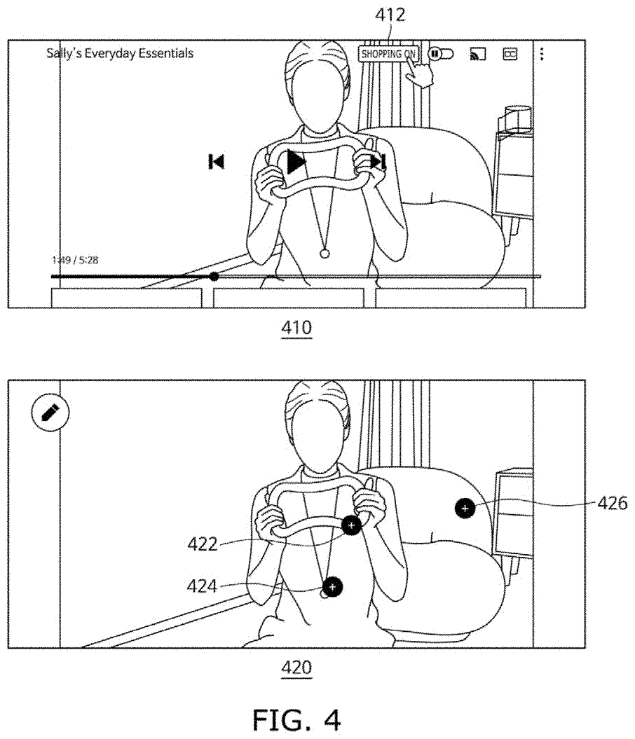

FIG. 4 illustrates an example of activating a shopping link function. As illustrated, the user may activate the shopping link function through a first operation 410 and a second operation 420. The first operation 410 illustrates an example in which an icon 412 for activating a shopping link function of a video being replayed (or paused) is output. The shopping link function may herein refer to a function of linking a video platform (or video player) that provides a corresponding video to an online shopping platform that provides online shopping information. For example, the shopping link function may include a function of providing online shopping information associated with the video to the user via the video platform. As another example, the shopping link function may include a function of moving from the video platform to the online shopping platform associated with the video.

The processor may output one or more tags 422, 424, and 426 by activating the shopping link function in response to the user input of selecting the icon 412. In this case, the tags 422, 424, and 426 may be associated with one or more objects included in the video. For example, the first tag 422 may be associated with a “yoga ring” object included in the video. As another example, the second tag 424 may be associated with a “necklace” object included in the video. As still another example, the third tag 426 may be associated with a “sofa” object included in the video.

The tags 422, 424, and 426 may be output at locations adjacent to the associated objects. For example, the first tag 422 may be output at a location adjacent to the “yoga ring” object in the video. As another example, the second tag 424 may be output at a location adjacent to the “necklace” object in the video. As still another example, the third tag 426 may be output at a location adjacent to the “sofa” object in the video.

In response to a user input of selecting one of the tags 422, 424, and 426, the processor may change at least one of a shape, an outline, or a color of the selected one tag and output the result. For example, the processor may change the color of the first tag 422 in response to a user input of selecting the first tag 422 from among the one or more tags 422, 424, and 426. With such a configuration, the user can easily check the object (“yoga ring”) associated with the tag selected by the user in the video that includes a plurality of objects, by checking the object positioned adjacent to the first tag 422 in the changed color. In some example embodiments, if the user selects one of the tags 422, 424, and 426, the online shopping information for the object associated with the selected tag may be output.

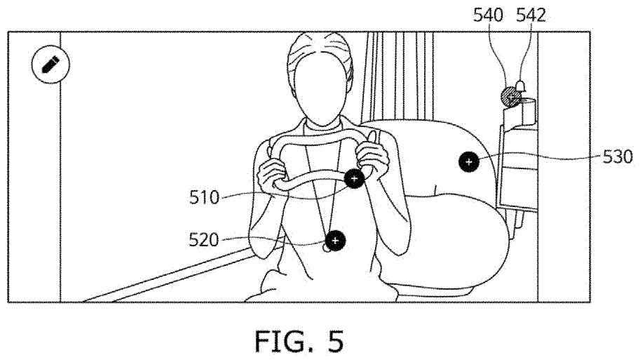

FIG. 5 illustrates an example in which a plurality of tags 510, 520, 530, and 540 are output. As illustrated, the processor may output the plurality of tags 510, 520, 530, and 540 associated with corresponding ones of a plurality of objects (“yoga ring”, “necklace”, “sofa”, “toilet paper”) included in the video, respectively. In this case, if the object included in the video is a consumable, the tag of the corresponding object may be displayed visually differently from the tags of the non-consumable objects.

In response to determining that the first object (“yoga ring”) is non-consumable, the first tag 510 associated with the first object (“yoga ring”) may be displayed with a first visual object. For example, the first visual object may be a figure such as a black circle with white “+” marked therein. Likewise, if the second object (“necklace”) and the third object (“sofa”) are non-consumables, the second tag 520 and the third tag 530 may be displayed with the first visual object. On the other hand, the fourth tag 540 associated with the fourth object (“toilet paper”) may be displayed with a second visual object different from the first visual object, in response to determining that the fourth object (“toilet paper”) is a consumable. For example, the second visual object may be a figure such as a hatched circle with white “+” marked therein.

The processor may output a third visual object 542 indicating that the time for purchasing the fourth object (or product) (“toilet paper”) that is a consumable has arrived, at a location adjacent to the fourth object (“toilet paper”). For example, the processor may output a third visual object in the shape of a bell, indicating that the time for purchasing the fourth object (“toilet paper”) that is a consumable has arrived, together with the fourth tag 540 at a location adjacent to the first object (“toilet paper”). For example, the processor may output the third visual object 542 indicating that the time for purchasing the fourth object (or product) (“toilet paper”) that is a consumable has arrived, at a location adjacent to the fourth object (“toilet paper”), in response to determining that a desired (or alternatively, predetermined) period of time (e.g., one week or one month) elapsed since the user purchased the fourth object (“toilet paper”) or a product similar to the fourth object, based on the purchase record of the online shopping platform of the user. With such a configuration, the user can purchase consumables without missing an appropriate time, without having to individually check whether or not various consumables with different usage cycles are exhausted.

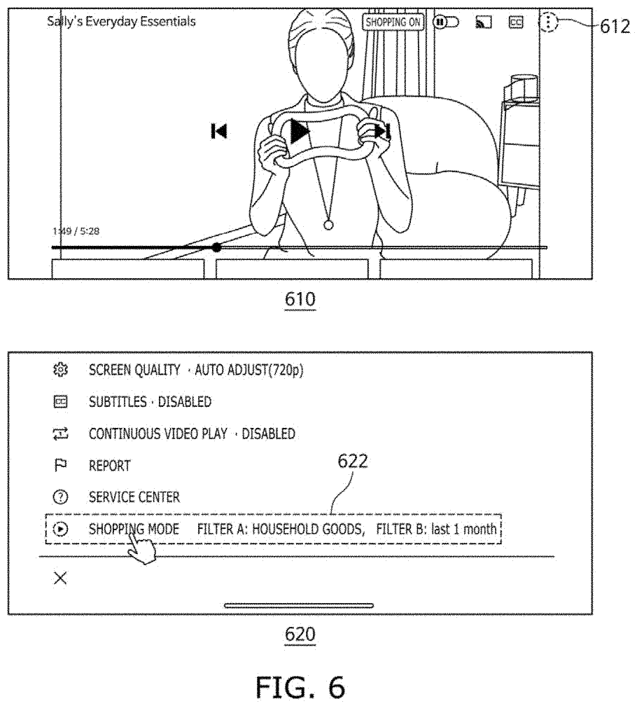

FIG. 6 illustrates an example of using a tag filter. As illustrated, the user may use the tag filter through a first operation 610 and a second operation 620. The first operation 610 represents an example in which the user selects a detailed setting icon 612 from a play menu of the video through a touch input or the like.

The second operation 620 represents an example in which the user sets a tag filter. In response to the user selecting the detailed setting icon 612 in the play menu of the video, the processor may output a detailed setting interface. The detailed setting interface may include a tag filter menu 622. The tag filter menu 622 may include a filter A and a filter B. The filter A is a menu for filtering tags displayed on the screen using a shopping category. For example, as illustrated, if the user selects “household goods” from the filter A item, only the tags associated with the products belonging to the household goods category may be displayed on the screen.

The filter B is a menu for filtering tags displayed on the screen using a recent search record and/or recent purchase record of the user. For example, if the user selects “recent searches—last 1 month” in the filter B, only the tags associated with the products that are the same as or similar to the products searched by the user during the last one month may be displayed on the screen. In another example, if the user selects “recent purchases—last 1 month” in the filter B, only the tag excluding the tags associated with the products that are the same as or similar to the products purchased by the user in last one month may be displayed on the screen. That is, only the tags associated with the products that are not the same as or similar to the products purchased by the user in last one month may be displayed on the screen.

With such a configuration, the user can mitigate or prevent an excessive number of tags from being displayed and interfere with the video watching while the video is playing, and allow only the tags that are likely to be of interest to be displayed.

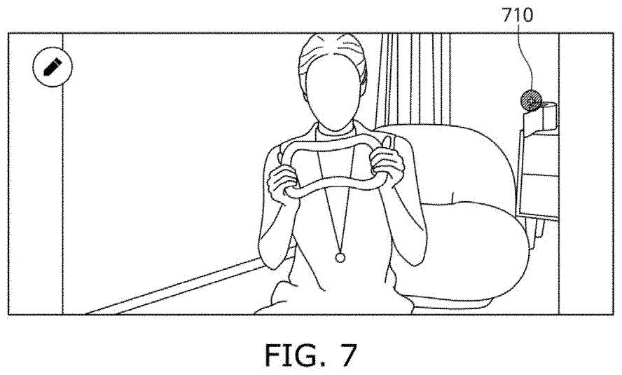

FIG. 7 illustrates an example in which the filter A is used. As illustrated, the processor may display a filtered tag 710 in response to a user input of selecting a specific shopping category from the filter A item. For example, if the user selects “household goods” from the filter A, only the tag 710 associated with a certain product (“toilet paper”) among the products (“yoga ring”, “necklace”, “sofa”, and “toilet paper”) included in the video may be displayed on the screen.

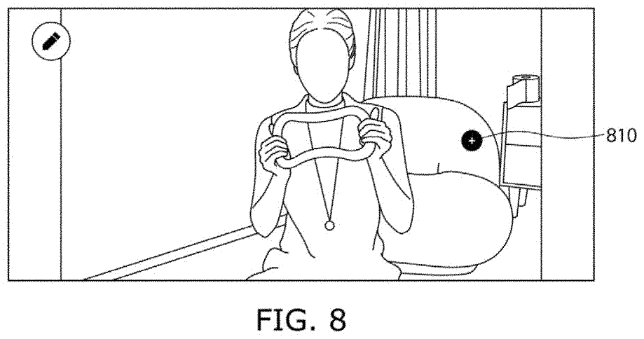

FIG. 8 illustrates an example in which the filter B is used. As illustrated, the processor may display a filtered tag 810 in response to a user input of selecting an item related to the recent search record and/or recent purchase record from the filter B item. That is, by the filter B, only the tag 710 associated with a certain product (“sofa”) among the products (“yoga ring”, “necklace”, “sofa”, and “toilet paper”) included in the video may be displayed.

For example, in response to a user input of selecting “recent searches—last 1 month” in the filter B, the processor may display only the tag 810 associated with the product same as or similar to the product (“sofa”) searched by the user during the last one month on the screen. In another example, in response to a user input of selecting “recent purchases—last 1 month” in the filter B, the processor may display, on the screen, only the tag 810 excluding tags associated with the products that are the same as or similar to the product (“sofa”) purchased by the user during the last one month.

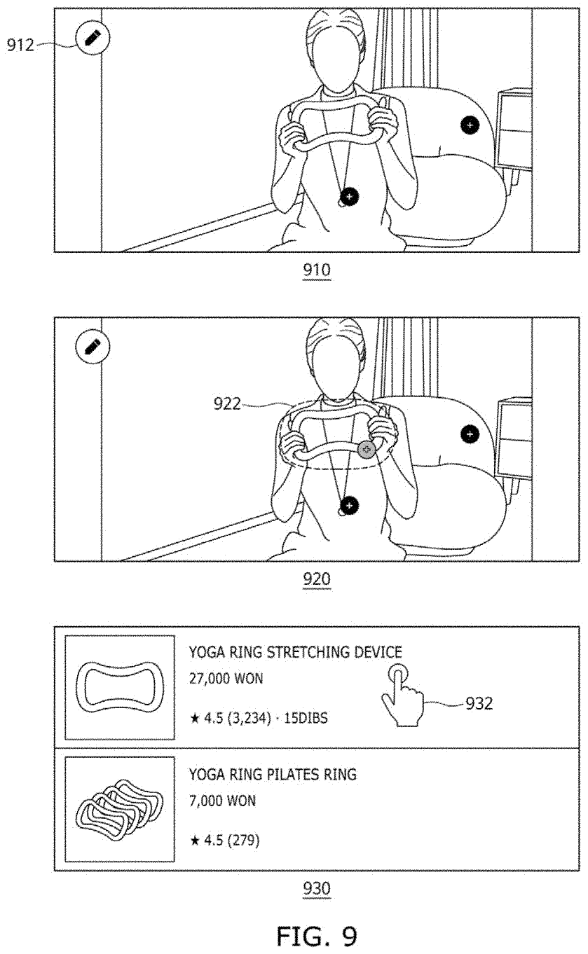

FIG. 9 illustrates an example of manually selecting an object in a video. As illustrated, if there is no tag in the object of interest in the video, through a first operation 910, a second operation 920, and a third operation 930, the user may manually select the object of interest in the video. The first operation 910 represents an example in which the user selects an icon 912 for manually selecting an object in the video. The processor may stop playing the video in response to a user input of selecting the icon 912. With such a configuration, the user can easily select a desired object from the still screen of the video.

The second operation 920 represents an example in which the user manually selects an object in the video for which a tag is not displayed. In this case, the fact that the tag is not displayed for the object in the video may mean that, in the online shopping platform, there is no registered product that is same as the object or has a similarity equal to or greater than the first threshold (e.g., 90%). If there is no product that is same as the object of interest displayed in the video or that has a similarity equal to or greater than a first desired (or alternatively, predetermined) threshold, some users may want to receive information on a product having a certain level of similarity or higher.

The user may draw any figure (e.g., a circle, a triangle, or a square) surrounding the object of interest (e.g., “yoga ring”) of the objects without any tags displayed, thereby selecting a specific object included in the screen during video play. In this case, in response to a user input of drawing a figure of any shape surrounding the object (“yoga ring”), the processor may output a figure object 922 corresponding to the figure drawn by the user. In another example, the user may rub an area of the object (“yoga ring”) to select the object. In this case, the processor may output, on the object (“yoga ring”), an object (not illustrated) in a form that is rubbed according to the user input. The user may manually select an object that is not associated with a tag, to receive shopping information of products having a similarity (e.g., similarity of 60% to 90%) equal to or greater than a second desired (or alternatively, predetermined) threshold (e.g., 60%) that is lower than the first threshold.

In some example embodiments, in response to a user input of surrounding or rubbing an object, the processor may output a user interface (not illustrated) for inputting information on a shopping category to which the object belongs. For example, the user may input to the user interface, the “exercise goods” which is a shopping category to which the object (“yoga ring”) belongs. The user may limit the shopping category of the unrecognized object so as to receive the shopping information of a product that belongs to the corresponding shopping category and that has a similarity equal to or greater than the second threshold (e.g., 60%).

The third operation 930 represents an example in which the manually selected object is displayed on the screen together with and a list of products having a similarity equal to or greater than the second threshold. The processor may output a second set of products (“yoga ring stretching device”, “yoga ring Pilates ring”, and the like) of the first set of products (that is, all products registered on the online shopping platform) registered in the online shopping platform, which are associated with product images having a similarity greater than or equal to the second desired (or alternatively, predetermined) threshold and less than or equal to the first desired (or alternatively, predetermined) threshold with respect to the object. In some example embodiments, the processor may output the second set of products (“yoga ring stretching device”, “yoga ring Pilates ring”, and the like) of the first set of products (that is, all products registered on the online shopping platform) registered in the online shopping platform, which are associated with product images belonging to the same shopping category (“exercise goods”) as the object (“yoga ring”) and which have a similarity greater than or equal to the second desired (or alternatively, predetermined) threshold and less than or equal to the first desired (or alternatively, predetermined) threshold.

In this case, the user may select one (e.g., product 932) of the second set of products (“yoga ring stretching device”, “yoga ring Pilates ring”, and the like), which is determined to have a higher similarity to the object (“yoga ring”) or for which the user has purchase intention. In response to receiving a user input for the product 932 of the second set of products, the processor may transmit information on the video (e.g., a link to the video and an identification number of the video), information on the object (“yoga ring”) (e.g., play time of the video and relevant area in the screen), and information on the one product 932 (link to the product for sale, an identifier for the product for sale, and the like) to the information processing system (e.g., 230 in FIG. 2). With such a configuration, the video service provider may accumulate the online shopping information associated with the object in the video.

Based on the information on the video, the information on the object, and the information on the one product, the information processing system may match and store, with respect to the corresponding video, the object manually selected by the user and the product for sale selected by the user. Accordingly, if another user watches the corresponding video later, a tag may be output at a location adjacent to the object (“yoga ring”), and if another user selects the corresponding tag, information on the corresponding product 932 (e.g., information on the product 932 selected by the user) may be output. In this case, a tag associated with the object manually selected by the user may be displayed in a visually different way than the tag automatically added by the system. For example, a tag automatically added by the system (e.g., an object having a similarity equal to or greater than the first threshold with respect to an image of a product registered on the online shopping platform) may be displayed with a visual object which may be a black circle with white “+” marked therein. Meanwhile, a tag manually added by the user (e.g., an object having a similarity equal to or greater than the second threshold and less than the first threshold with respect to an image of a product registered in the online shopping platform) may be displayed with a visual object which may be a gray circle with white “+” marked therein. With such a configuration, the video service provider may accumulate the online shopping information associated with the object in the video.

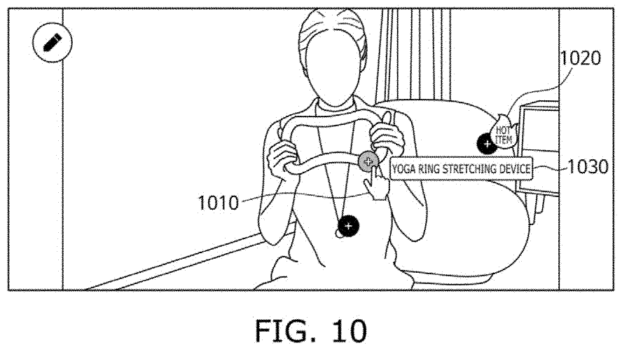

FIG. 10 illustrates an example of displaying a visual object 1020 indicating a popular product. As illustrated, if a cursor 1010 is placed on a tag, the processor may output representative product information 1030 for an object (“yoga ring”) associated with the corresponding tag. For example, if the cursor 1010 is placed on a tag, the processor may output the representative product information 1030 (“yoga ring stretching device”) registered in the online shopping platform associated with the object (“yoga ring”) associated with the corresponding tag. In some example embodiments, if the cursor 1010 is placed on the tag, the processor may output a phrase input by another user who manually selected the corresponding tag (e.g., product information input by another user)

If the object (“sofa”) included in the video is a popular product, the visual object 1020 may be output, indicating that the object is a popular product. In this case, by the “popular product,” it may refer to a product for which the number of users who clicked a tag associated with the object (“sofa”) and/or purchased a related product registered in the online shopping mall while the video is playing, is equal to or greater than a desired (or alternatively, predetermined) threshold (e.g., 1,000). For example, as illustrated, in response to determining that the number of users who selected the tag associated with the object (“sofa”) and purchased the product associated with the object while the video is playing is equal to or greater than the desired (or alternatively, predetermined) threshold, the processor may output, at a location adjacent to the object (“sofa”), the tag and the visual object 1020 indicating that the corresponding object is a popular product together. For example, the visual object may be a flame-shaped visual object marked with “HOT ITEM”. As another example, the visual object may be a visual object marked with “TOP” or “BEST”.

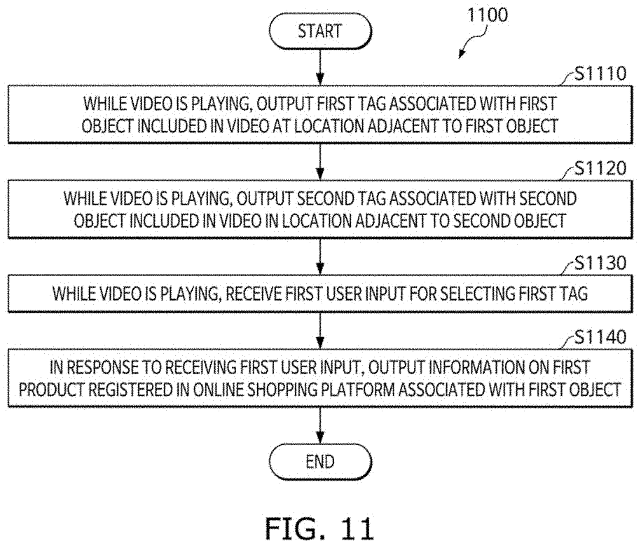

FIG. 11 illustrates an example of a method 1100 for providing online shopping information based on video analysis. The method 1100 may be performed by one or more processors (e.g., 314 of FIG. 3) of the user terminal. As illustrated, the method 1100 may be initiated by outputting, while the video is playing, a first tag associated with a first object included in a video at a location adjacent to the first object, at S1110. Additionally, the processor may output, while the video is playing, a second tag associated with a second object included in the video at a location adjacent to the second object, at S1120.

The first tag and the second tag may be displayed if the user activates a shopping link function at a video player. In another example, the first tag and the second tag may be output in response to determining that the first object and the second object belong to a specific shopping category selected by the user. In another example, the first tag and the second tag may be output in response to determining that the first object and the second object are not associated with the product purchased by the user within a second desired (or alternatively, predetermined) period of time.

The first tag may be displayed with a third visual object in response to determining that the first object is a consumable, and the second tag may be displayed with a fourth visual object in response to determining that the second object is a non-consumable item. In this case, the third visual object and the fourth visual object may be different from each other. Additionally, the processor may be configured to, in response to determining that a third desired (or alternatively, predetermined) period of time has elapsed since the purchase of the first object by the user based on the purchase record in the online shopping platform of the user, output a fifth visual object indicating that the time for purchasing the first product that is a consumable has arrived, together with the first tag at a location adjacent to the first object. Additionally or in some example embodiments, in response to determining that the number of users who selected the first tag and purchased the first product while the video is playing is equal to or greater than a third desired (or alternatively, predetermined) threshold, the processor may output a sixth visual object indicating that the first product is a popular product, together with the first tag at a location adjacent to the first object.

The processor may receive a first user input of selecting the first tag, while the video is playing, at S1130. In response to receiving the first user input, the processor may output information on the first product registered in the online shopping platform associated with the first object, at S1140. In this case, the information on the first product may include at least one of a sale price, seller information, buyer rating information, and a product image.

The first object included in the video may have a similarity equal to or greater than the first desired (or alternatively, predetermined) threshold with respect to the product image included in the information on the first product. Additionally, the second object included in the video may have a similarity equal to or greater than the second desired (or alternatively, predetermined) threshold and less than the first desired (or alternatively, predetermined) threshold with respect to the product image of the second product registered in the online shopping platform. In this case, the first tag may be displayed with the first visual object, and the second tag may be displayed with the second visual object different from the first visual object.

The processor may receive a second user input of selecting an icon for purchasing the first product. In response to receiving the second user input, the processor may output a web page for purchasing the first product on the online shopping platform.

The processor may receive a third user input of selecting an icon for a user to manually select an object in the video. In response to receiving the third user input, the processor may stop playing the video and receive a fourth user input of selecting a third object in the video. In this case, the fourth user input may be a user input of drawing a figure of any shape surrounding the third object. In addition, the fourth user input may be a user input of rubbing an area corresponding to the third object.

The processor may output a user interface for inputting information on a shopping category to which the third object belongs. Then, the processor may output a second set of products of the first set of products registered in the online shopping platform, in which the second set of products belong to the same shopping category as the third object and associated with a product image having a similarity equal to or greater than the third desired (or alternatively, predetermined) threshold with respect to the third object. Additionally, the processor may receive, as a fifth user input, selecting of a second product of the second set of products. In response to receiving the fifth user input, the processor may transmit information on the video, information on the third object, and information on the second product to the information processing system.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies according to design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with processing circuitry (e.g., general purpose processors, DSPs, ASICs, FPGAs or other programmable logic devices), discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the example examples described above have been described as utilizing aspects of the currently disclosed subject matter in one or more standalone computer systems, aspects are not limited thereto, and may be implemented in conjunction with any computing environment, such as a network or distributed computing environment. Furthermore, the example embodiments in the present disclosure may be implemented in multiple processing chips or devices, and storage may be similarly influenced across a plurality of devices. Such devices may include PCs, network servers, and portable devices.

According to methods (or systems) of the above examples, a user may check online shopping information associated with a product appearing in the video being played referring to information on products for sale registered in an online shopping platform, without a producer of a video manually inputting information on the product to be sold. Thus, there is no need to produce a separate video for the purpose of introducing a product to be sold nor no need to manually register information on a product to be sold, thereby reducing consumption of computing resources and a video production time.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method for providing online shopping information based on video analysis, the method being performed by one or more processors of a user terminal, the method comprising:
while a video is playing, outputting a first tag associated with a first object included in the video, at a location adjacent to the first object;
while the video is playing, outputting a second tag associated with a second object included in the video, at a location adjacent to the second object;
while the video is playing, receiving a first user input of selecting the first tag, the first user input being a first input of a user of the user terminal; and
in response to receiving the first user input, outputting information on a first product registered in an online shopping platform associated with the first object.

2. The method according to claim 1, wherein the first tag and the second tag are displayed if the user activates a shopping link function at a video player.

3. The method according to claim 1, wherein the information on the first product includes at least one of a sale price, seller information, buyer rating information, and a product image.

4. The method according to claim 3, wherein the first object included in the video has a similarity equal to or greater than a first threshold with respect to the product image included in the information on the first product.

5. The method according to claim 4, wherein:
the second object included in the video has a similarity equal to or greater than a second threshold and less than the first threshold with respect to a product image of a second product registered in an online shopping platform;
the first tag is displayed with a first visual object; and
the second tag is displayed with a second visual object different from the first visual object.

6. The method according to claim 1, further comprising:
receiving a second user input of selecting an icon for purchasing the first product, the second user input being a second input of the user; and
in response to receiving the second user input, outputting a web page for purchasing the first product on the online shopping platform.

7. The method according to claim 1, wherein the first tag and the second tag are output in response to determining that the first object and the second object belong to a specific shopping category selected by a user.

8. The method according to claim 1, wherein the first tag and the second tag are output in response to determining that the first object and the second object are associated with a product searched by the user within a period of time.

9. The method according to claim 1, wherein the first tag and the second tag are output in response to determining that the first object and the second object are not associated with a product purchased by a user within a period of time.

10. The method according to claim 1, wherein:
the first tag is displayed with a first visual object, in response to determining that the first object is a consumable;
the second tag is displayed with a second visual object, in response to determining that the second object is a non-consumable item; and
the first visual object and the second visual object are different from each other.

11. The method according to claim 10, further comprising:
in response to determining that a period of time has elapsed since a purchase of the first object by the user based on a purchase record of the user in the online shopping platform, outputting a third visual object indicating that a time for purchasing the first product that is a consumable has arrived, together with the first tag, at a location adjacent to the first object.

12. The method according to claim 1, further comprising:
in response to determining that a number of users who have selected the first tag and purchased the first product while the video is playing is equal to or greater than a threshold, outputting a visual object indicating that the first product is a popular product, together with the first tag, at a location adjacent to the first object.

13. The method according to claim 1, further comprising:
receiving a third user input of selecting an icon for the user to manually select an object in a video, the third user input being a third input of the user;
in response to receiving the third user input, stopping play of the video; and
receiving a fourth user input of selecting a third object in the video, the fourth user input being a fourth input of the user.

14. The method according to claim 13, wherein the fourth user input is a user input of drawing a figure of any shape surrounding the third object.

15. The method according to claim 13, wherein the fourth user input is a user input of rubbing an area corresponding to the third object.

16. The method according to claim 13, further comprising:
outputting a user interface for inputting information on a shopping category to which the third object belongs.

17. The method according to claim 16, further comprising:
outputting a second set of products of the first set of products registered in the online shopping platform, the second set of products belonging to a same shopping category as the third object and associated with a product image having a similarity equal to or greater than a threshold with respect to the third object; and
receiving, as a fifth user input, a selection of a second product from among the second set of products, the fifth user input being a fifth input of the user, the second set of products being a subset of the first set of products.

18. The method according to claim 17, further comprising:
in response to receiving the fifth user input, transmitting information on the video, information on the third object, and information on the second product to an information processing system.

19. A non-transitory computer-readable recording medium storing instructions that, when executed by one or more processors, cause a user terminal to perform the method according to claim 1.

20. A user terminal, comprising:
a memory; and
one or more processors connected to the memory and configured to execute one or more computer-readable programs included in the memory such that the one or more processors are configured to perform a method, the method comprising:
while a video is playing, outputting a first tag associated with a first object included in the video, at a location adjacent to the first object;
while the video is playing, outputting a second tag associated with a second object included in the video, at a location adjacent to the second object;
while the video is playing, receiving a first user input of selecting the first tag, the first user input being a first input of a user of the user terminal; and
in response to receiving the first user input, outputting information on a first product registered in an online shopping platform associated with the first object.
